(19) United States
(12) Patent Application Publication
(10) Pub. No.: US 2008/0246990 A1
(43) Pub. Date: Oct. 9, 2008

(54) Mixed Colour Remote Printing of Recipient Documents

(75) Inventor: Russell Allen Brockhurst, Carindale (AU)

Correspondence Address: FENWICK & WEST LLP, SILICON VALLEY CENTER, 801 CALIFORNIA STREET, MOUNTAIN VIEW, CA, 94041, US

(73) Assignee: EPIP PTY LTD., West End (AU)

(21) Appl. No.: 12/060,748

(22) Filed: Apr. 1, 2008

(30) Foreign Application Priority Data
Apr. 3, 2007 (AU) 2007201473

(51) Int. Cl. G06K 15/00

(52) U.S. Cl. 358/1.15

(57) ABSTRACT

An automated hybrid mail system/method which sends a recipient document including one or more graphic image files from a sender to a recipient. The system/method includes receiving an electronic document transmitted from terminal, the electronic document includes a pack containing an ordered set of graphic image files. The graphic image files are obtained from one or more application documents. The system/method provides mixed colour printing of the recipient document including more than one page. The method includes sending the recipient document to a printer able to print the recipient document. Each page of the recipient document is previously assigned a colour mode prior to printing, the colour mode indicative of monochrome, colour or pattern printing. The colour mode indicative of pattern printing results in each page of the recipient document printing in either monochrome or colour according to the colour mode assigned to a section to which the page belongs.

### RELATED APPLICATIONS

This application claims the priority benefit under 35 U.S.C. §119 of Australian Patent Application No. 2007201473, filed on Apr. 3, 2007.

### TECHNICAL FIELD

The present invention relates to a method, system, computer program product and/or computer readable medium of instructions for mixed colour printing of recipient documents. More particularly, one or more graphic image files are transmitted from a computer terminal to at least one server as part of an electronic document for onward delivery of the one or more graphic image files to a recipient, for example to be printed on physical media as a recipient document, where different pages and/or sections of a recipient document can be printed in either colour or monochrome to provide mixed colour printing.

### BACKGROUND ART

Australian Patent No. 2003254402, filed on 28 Aug. 2003 by the present Applicant, is directed to an automated hybrid mail system/method which sends a graphic image file from a sender's terminal into a postal network via a remote printing facility. The system can check the recipient's address is correctly located on the graphic image file before sending and (optionally) verifying the recipient's address and adding a correct Delivery Point ID and bar code. However, the system disclosed in Australian Patent No. 2003254402 does not provide for mixed colour printing, as hereinafter discussed, which provides a significant advantage and improvement over this prior system.

In the system disclosed in Australian Patent No. 2003254402, there exists a problem in that a recipient document, when incorporating multiple pages, requires that all pages of the recipient document be printed in either monochrome (greyscale) or colour. The applicant has identified a need for providing mixed colour printing, where a mixed colour printed recipient document can have some pages of the recipient document printed in monochrome and some pages of the recipient document printed in colour.

This identifies a need for a method, system, computer program product and/or computer readable medium of instructions for mixed colour printing.

### Definitions

‘Terminal’ means a device in a networked data or information communications system which is capable of requesting and receiving information from local or remote information sources. The capability of the terminal to request and/or receive information can be provided by an application program, hardware or other such entity. A terminal may be provided with associated devices, for example an information storage device such as a hard disk drive and a display screen. A terminal may be a computer or computerised device, a personal computer (PC), a type of mobile or cellular phone, a mobile data terminal, a portable computer, a personal digital assistant (PDA), a pager, a thin client, or any other similar type of electronic device.

‘Computer network’ as referenced in this specification should be taken to include all forms of connected or communicating terminals having at least two terminals connected or communicating so as to be able to transfer information or data. That is, the term computer network should be taken to include any type of terminal or part thereof, as defined herein, which is rendered such that it is capable of communicating with at least one other terminal. The communication of information or data can occur over any data communications network, computer network, wireless network, inter-network, intra-network, local area network (LAN), wide area network (WAN), the Internet and developments thereof, transient or temporary network, combinations of the above or any other type of network providing for computerised, electronic or digital devices.

‘Postal network’ means any form of network or system for distribution of physical mail, such as hardcopy documents or letters, and includes government or private postal services, a firm of couriers, or any other network or system whereby a hardcopy document can be delivered to a recipient's physical address.

‘Application document’ means a document produced by a user on a terminal using any application program, or received by a user on a terminal. Examples of application documents include word-processing documents produced by, say, Microsoft® Word, a spreadsheet, an invoice produced from an accounting package, or a document produced by a desktop publishing package.

‘Graphic Image File’ means an electronic file with graphical information that can be used to reproduce an original application document in a form whereby what the user sees on the terminal screen is the same as when the graphic image file is printed. An example of a graphic image file could be a file in Postscript, Portable Document Format (PDF), Printer Command Language (PCL), Microsoft® Enhanced Metafile Format (EMF), XPS, JPEG, TIF, or BMP.

‘Electronic document’ means an electronic file that can be stored on a terminal and/or transmitted over a computer network.

‘Hardcopy document’ means a document printed on paper or other physical media.

### DISCLOSURE OF INVENTION

According to various aspects, the present invention provides a method, system, computer program product and/or computer readable medium of instructions for mixed colour printing of a recipient document which includes a plurality pages. The term section is used as a general reference to describe any type of collection or grouping of multiple pages, including for example, a single or multiple page letter, a set of letters, an attachment or set of attachments, or some other type of page or set of pages. The printed recipient document is preferably a hardcopy document including a plurality of pages.

According to a particular aspect, the present invention provides that one or more graphic image files are transmitted from a computer terminal to one or more server as part of at least one electronic document for onward delivery of the one or more graphic image files, for example to be printed on physical media as a plurality of pages, to a recipient, where the plurality of pages form at least one recipient document and different pages and/or sections of the recipient document can be printed in either colour or monochrome to provide mixed colour printing.

In example applications of the present invention, a mixed colour recipient document could have a first page of a letter printed in colour and all other pages printed in monochrome. Alternatively, for example, a recipient document could include a cover letter printed in monochrome and one or more attachment pages printed in colour. A wide variety of different combinations of mixed colour and monochrome printing for multiple page recipient documents is possible, with or without associated attachments, inserts, additional material, cover sheets, or the like forming part of a recipient document.

While different users may have different requirements for mixed colour printing, individual users are likely to send many recipient documents using the same mixed colour patterns, e.g. first page colour, black and white attachments, colour attachments, etc., and thus a variety of user selectable mixed colour printing options can be provided for users. Furthermore, a user interface can be provided that gives an end user a relatively simple means to control the use of mixed colour printing and where a default behaviour or options may be customised to match the user's most common pattern(s) of use.

In a first aspect, there is provided a method of mixed colour printing of a recipient document including more than one page, the method including: (a) receiving, at one or more servers, an electronic document transmitted from a terminal, the electronic document including a pack, the pack including one or more sections, a section including one or more pages; (b) obtaining the recipient document from the pack; and, (c) sending the recipient document, from the one or more servers, to a printer able to print one or more graphic image files forming the recipient document; wherein, the one or more pages of the pack are assigned a colour mode prior to printing, the colour mode indicative of monochrome, colour or pattern printing.

In a second aspect, there is provided a system for mixed colour printing of a recipient document including more than one page, the system including: one or more servers to receive an electronic document transmitted from a terminal, the electronic document including a pack, the pack including one or more sections, a section including one or more pages, and the one or more servers able to transmit a recipient document to a printer for printing of the recipient document; wherein, the one or more pages of the pack are assigned a colour mode prior to printing, the colour mode indicative of monochrome, colour or pattern printing.

In a third aspect, there is provided a computer program product for mixed colour printing of a recipient document including more than one page, the computer program product configured to: (a) receive, at one or more servers, an electronic document transmitted from a terminal, the electronic document including a pack, the pack including one or more sections, a section including one or more pages; and, (b) send the recipient document, from the one or more servers, to a printer able to print the recipient document; wherein, the one or more pages of the pack are assigned a colour mode prior to printing, the colour mode indicative of monochrome, colour or pattern printing.

In an example form, if a section is assigned the colour mode indicative of monochrome printing, then all pages of the section are printed in monochrome.

In another example form, if a section is assigned the colour mode indicative of colour printing, then all pages of the section are printed in colour.

In another example form, a section provides an attachment, and a colour mode is assigned to each page of the attachment.

Preferably, the colour mode assigned to each page of a section is a result of a user selecting a colour pattern.

According to a particular aspect, the colour pattern may be selected from a group with elements representative of: ‘first page colour’, ‘first page colour with colour attachments’, ‘first page colour with monochrome attachments’, and ‘first page monochrome with colour attachments’.

According to another particular aspect, more than one section is provided as a pack and the pack is assigned a colour mode, and wherein if the pack is assigned pattern colour mode, then colour or monochrome printing for each page is determined by the colour mode assigned to the section to which a page belongs.

According to another particular aspect, more than one section is provided as a pack and the pack is assigned a colour mode, and wherein if the pack is assigned the pattern colour mode, the selected pattern is applied to all sections and pages that have also been assigned the pattern colour mode. The selected pattern may be over-ridden by assigning specific colour modes to individual recipient documents, sections (e.g. letters) or pages.

In another example form, a section provides an attachment, and a colour mode is assigned to each page of the attachment. The colour mode assigned to each page of the section may be a result of a user selecting a colour pattern at the terminal.

It should be appreciated that a preferred embodiment is not limited to delivery of printed documents into a postal network. For example, a document may be delivered to a recipient by post, email or facsimile from a server. However, further description of an embodiment utilizing delivery by post is given by way of example.

It should be noted that the application document itself need not necessarily actually be produced on the client terminal, the application document could be produced elsewhere and sent to the client terminal. Also, the sender need not necessarily be the creator of the application document.

In a particular form, a representation of a unique identification number is added to the graphic image file or the hardcopy document, for example as a bar code or magnetic code, and this representation of the unique identification number can be used for tracking, for example within a postal network until a hardcopy document reaches the recipient or recipient's address. Preferably, if an optical code, such as a bar code, is used the code is readable through the window of an envelope. This allows the document to be tracked from creation to delivery in both electronic and physical form.

In a further particular form, the server (or network of servers) receives notification of receipt and/or printing and onward delivery of the hardcopy document and updates records in a database, and/or notifies the sender of this action. Details of the transaction can also be recorded in the database for billing purposes.

In another embodiment, an electronic document received by the server can be quarantined on the server if a sender's account is not active, for example if the sender has not made previous payments, has no account or has no credit. An electronic notification can be sent to the client terminal alerting the sender to the electronic document having been quarantined.

In a particular example, when intended for delivery into a postal network the graphic image file may be routed to a printer close or closest to, or most conveniently located to, the indicated recipient's address. Also preferably, the sender is only required to instruct the client-side software to transmit the electronic document to the server, with the client-side software and/or server-side software handling further aspects of delivery into the postal network.

In various alternative forms, the position of the recipient's address, for example in a graphic image file, can be checked by:

the client-side software;

the sender, by way of the graphic image file being presented in a preview screen with a recipient address boundary mask overlayed; and/or

the server-side software rechecking the position.

In a further example embodiment, the client-side software resident on the client terminal, or the server-side software, extracts the text positioned at the location of the recipient's address area from the graphic image file and attempts to verify that the text constitutes a valid address. For example, by checking that a valid postcode or suburb name has been included. In another form, optical scanning recognition software is used to convert the recipient address component of the graphic image file to text form, which is then checked to seek to verify that the text constitutes a valid address.

According to still further aspects, the graphic image file can be checked to verify the graphic image file can be processed by a mailhouse. The checks can include: that the fonts in the graphic image file are supported by the mailhouse; an address is provided; and/or a valid address is provided according to parameters for correct addressing in the destination country. Also, the graphic image file could be moved or re-sized to allow for page barcodes, or other indicia inserted by the mailhouse.

In another example form, the client-side software, or the server-side software, reads and looks up the recipient's address in a postal address file and generates an address representation, for example a barcode representation of the recipient's address or a suitable Delivery Point Identification (DPID) to facilitate transmission to an appropriate printer and/or the recipient.

In a particular example embodiment, the client-side software allows the sender to preview the graphic image file and displays an overlay or mask showing the preferred location for the recipient's address. Moreover, the client-side software allows the sender to relocate or delete the graphical elements that form the graphic image file whilst in this preview mode. For example, the position of the recipient's address could be relocated if not within the preferred location. The software may also provide the sender with the option to delete components in the address area and to manually type in text indicating a correct address, which is then incorporated into the graphic image file before transmission of the electronic document to the server.

The client-side software can compress and/or encode the graphic image file into a format suitable for electronic transmission. Furthermore, according to a particular embodiment, the client-side software encrypts the electronic document using public key encryption before electronically transmitting the electronic document to the server. The electronic document can also be digitally signed.

In a particular example form, the server is programmed with rules that enable the server to forward the graphic image file from the received electronic document to a printer close or closest to, or most conveniently located to, the recipient's address.

According to a further particular form, in the case where the application document consists of a set of separate documents to be delivered to separate recipients—for example, the results of a mail merge job in a word-processing application—special codes are incorporated at the end and/or beginning of the mail merge template to establish the start and the end of individual application documents. This allows a large mail merge job to be separated into the individual component documents at the client terminal, which further allows the documents to be processed on the server without human intervention. Also, an analysis of the structure of each application document can be performed to determine start and end points of each of the documents or collection of documents.

In a particular embodiment, one or more printers, when utilised, may be managed by a printer server which receives the graphic image file and sends an electronic notification message back to the originating server.

In a further example mode of operation, one or more printers, when utilised, are integrated into a postal network and all necessary facilities for printing, folding, inserting and lodgement of hardcopy documents into the postal network is provided.

In a particular embodiment, one or more printers, when utilised, can be managed by a server computer (or network of servers) which manages the process of receiving the graphic image files, decoding the graphic image files, and printing the hardcopy document. In another embodiment, these printer servers can be programmed with rules to forward graphic image files to other printers in the event of printer breakdown or overloading.

According to another embodiment, the system/method can be designed to operate as a multi-level distribution system/method where intermediate resellers and individual salespersons can be cross-linked to the final mailed hardcopy document and be provided with a commission based on transaction value.

### BRIEF DESCRIPTION OF FIGURES

The present invention should become better understood from the following detailed description of a preferred but non-limiting embodiment thereof, described in connection with the accompanying figures, wherein:

FIG. 1 illustrates a general system providing a non-limiting example embodiment;

FIG. 2 illustrates how the client terminal can query the delivery status of an electronic document;

FIG. 3 illustrates a possible billing system structure;

FIG. 4 illustrates an example embodiment including use of a regular expression;

FIG. 5 illustrates an example embodiment for matching physical media to electronic documents;

FIG. 6 illustrates an example method of mixed colour printing;

FIG. 7A illustrates an example pack used to produce one or more recipient documents; and,

FIG. 7B illustrates a further example pack used to produce one or more recipients documents using a mail merge process.

### MODES FOR CARRYING OUT THE INVENTION

In preferred, but non-limiting embodiments of the present invention, there is provided a method, system, computer program product and/or computer readable medium of instructions to facilitate improved delivery of a hardcopy and/or an electronic copy of an application document, which in one example form is delivery of one or more hardcopy documents as part of a letter, recipient document, or the like, via a postal network. However, it should be appreciated that the present invention is not limited to delivery of printed documents into a postal network. For example, a document may be delivered by post, email or facsimile via one or more servers.

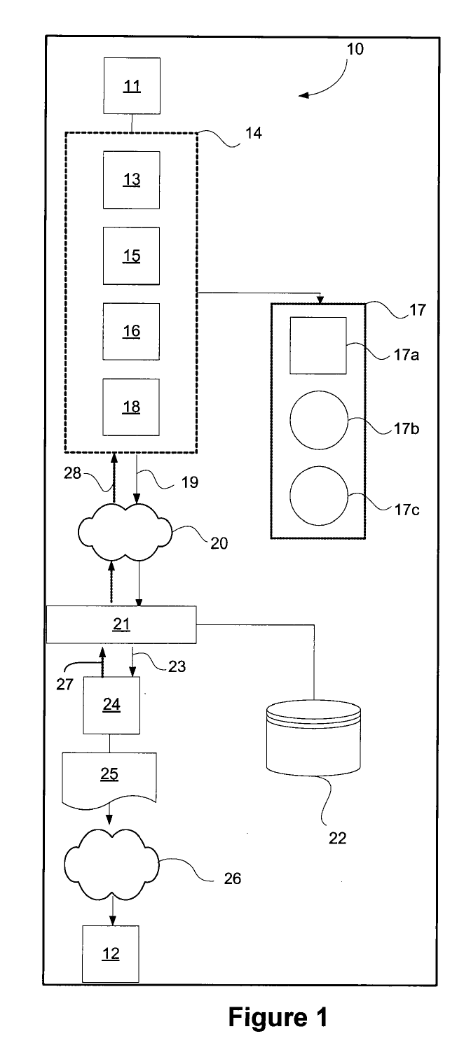

Referring to FIG. 1, there is illustrated a system 10 for facilitating a sender 11 to post a hardcopy document, or otherwise deliver a graphic image file, of an application document to a recipient 12. The application document 13 is created on the client terminal 14 by the sender 11 using a software application. Alternatively, the application document 13 may simply be received on the client terminal 14, being created on a different terminal.

The sender 11 uses software resident on the client terminal 14 to convert the application document 13 into a graphic image file by using an image capture tool 15. Preferably, this image capture tool exists as a printer driver which can be selected from within a standard software program provided with a print function. This produces a graphic image file from the application document, or multiple graphic image files of a multiple page application document.

The automated address checking procedure 16 checks the location of the recipient's address in the graphic image file. The automated address checking procedure 16 can also check that the postal address is valid. The automated address checking procedure 16 determines if there is text in the correct location or uses a preview screen with a mask overlay to determine address field boundaries, or allow the sender to manually inspect the address position. If there is text and the text appears to be a valid address, for example there is a recognisable postcode or suburb name, then the automated address checking procedure 16 can generate a barcode representation of the address and/or look up the address in a postal address file and generate a suitable address representation (e.g. barcode) or Delivery Point Identification (DPID) to assist in forwarding the graphic image file to an appropriate printer. If the address is not satisfactory or not valid, the software can prompt the sender 11 to correct the address. In an alternative particular embodiment, the user checks the address location visually using a preview screen with a boundary mask showing the correct location of the address. In a further alternative embodiment, the sender can type in the recipient's address manually or retrieve the recipient's address from an electronic address book database on the terminal.

According to various non-limiting embodiments, the following general steps can be provided:
1. Letters and attachments, as application documents, are captured or generated using a printer driver.
2. The graphic image file produced by the printer driver has a default standard address area, that may or may not correspond to a standard location for the address to be visible through the window of a window envelope. The default standard address area occurs if no previous manual selection has been made.
3. The address location that was last manually selected by the user/sender can be remembered, for example if the application document has the same name or other indicator.
4. The user can overwrite any automatic or previous manual address location selection by manually selecting an address area. This manual selection can occur by the user making a single mouse click, multiple mouse clicks, or drawing or dragging a rectangle around or over all or part of the address.
5. Application documents or graphic image files can be automatically identified and an associated target address can be extracted, even if parts of the address stray outside of a selected address area.
6. Margins in an application document or corresponding graphic image file can be checked to ensure that room is provided for page barcodes, optical mark recognition codes, or other suitable identifiers/codes. If the margins are too small the page image can be automatically, or manually, shifted or reduced to clear the required margin space.
7. The address location/window can be checked to see that it only includes the target or intended address. If the address window is not clear, i.e. it may contain unwanted text or images, a cover page can be added to the graphic image file (i.e. letter to be mailed) with the address located in a correct position on the cover page, for example for correct display of the address through the window of a window envelope. The address location in the cover sheet could be inserted or manipulated as per preceding steps 2, 3 or 4.
8. Optionally, the target address can be analysed to check that it appears to be a correct or valid address. Preferably, but not necessarily, this process occurs on the client terminal, it could occur on the server. The address may be corrected according to local postal standards, for example for format, barcode or DPID. If the address is amended, the new address is then placed in the address window, whether it be a first page of a letter or a cover page as previously discussed. Alternatively, the address can be checked against a database of correct or valid addresses. If the address does not match, an address from the database can be used. The database could reside local or remote to the client terminal.
9. Page barcodes, optical mark recognition codes, or other suitable identifiers/codes, can be added to any or all of the pages of the graphic image file (letter), including any cover sheet.
10. A graphic image file, i.e. letter, once transmitted, can then be sorted according to local postal standards, for example by postcode or suburb, and then printed, folded, inserted into an envelope for entry into the standard physical postal network.

When the recipient's address is satisfactory, the graphic image file is (optionally) compressed and encoded, the client-side software then creates an electronic document 17 which includes the graphic image file 17a, a unique identification number 17b (for tracking the graphic image file or electronic document) and an instruction file 17c. Preferably, but not necessarily, the electronic document 17 is also encrypted and can include a digital signature. Also preferably, but not necessarily, the unique identification number 17b may form part of the instruction file 17c. The instruction file 17c is preferably an XML file containing instructions for the handling of the electronic document 17, for example the instruction file 17c may contain, inter alia:

the unique identification number 17b, used to track the electronic document and for billing purposes;

the sender's account number or details, used for billing and verification purposes, and for the prevention of fraudulent use;

a unique identifier for the client terminal 14, used for tracking and verification of authenticity;

the number of pages or a return email address;

identification numbers for any intermediate resellers, and any individual salespersons, who are involved in a multi-level distribution of the present system, the identification numbers could be used to calculate commissions due to salespersons or sales-teams, for example the intermediate reseller identification numbers can be stored in the database 22 indexed against the sender's account number; and/or

printing instructions, for example colour or monochrome (greyscale, black and white), post via express mail, etc.

The electronic document 17 is passed to a queue manager 18 and then electronically transmitted 19 from the client terminal 14 over the computer network 20 to the server computer 21 (which may be a network of computers).

The queue manager 18 can send the electronic document 17 immediately or send several electronic documents in a batch. A server computer message handler receives the electronic document 17, and if required performs decoding/decrypting, verifies the digital signature, and extracts the recipient's address, postcode and/or DPID from the instruction file 17c. Optionally, the server-side software resident on the server 21 can perform further address checking, similar to the automated address checking procedure 16 on the client terminal 14, as an additional checking procedure.

The server-side software can handle incoming electronic documents, check the sender's account status, parse the instruction file associated with an electronic document, decode any encoded format files, decrypt and verify data, extract a recipient's address, track the incoming electronic document, record billing data, handle errors, manage the printing of the hardcopy document, re-encrypt and forward an electronic document to another remote server, or transmit the electronic document using another form of communication. Furthermore, the server-side software can handle onward sending of an email including at least the graphic image file and/or facsimile transmission of at least the graphic image file. Email or facsimile transmission to a recipient may be handled by a separate server(s) or the server receiving the electronic document.

An electronic document 17 received by the server 21 can be quarantined on the server 21 if a sender's account is not active, for example if the sender has not made previous payments, has no account or has no credit. An electronic notification 28 can be sent to the client terminal 14 alerting the sender 11 to the electronic document 17 having been quarantined.

After verifying the sender's account details, this information is passed to a message forwarder in the server computer 21 which follows a set of rules to decide which is a suitable mail distribution centre printer to receive the graphic image file 17a, for example which is the closest mail distribution centre printer to the recipient's address. Information concerning the receipt or transmittal of electronic documents, graphic image files or any other information relating to the transaction, for example data from the instruction file 17c, can be recorded in the database 22.

The graphic image file 17a is electronically transmitted 23 to the selected printer/printer server 24, and the server 21 records the transaction in the database 22, which can be indexed by the unique identification number 17b.

The printer/printer server 24 sends an electronic notification message 27 back to the server computer 21 detailing the results of the printing operation. On receipt of the electronic notification message 27, the server-side software updates the database 22 and, either automatically or if requested (i.e. optionally), forwards a further electronic notification message 28 to the client terminal 14 so as to inform the sender 11 of the success, or otherwise, of the delivery of the hardcopy document 25 into the postal network 26. The electronic notification message 28 could also be initially either automatically or if requested (i.e. optionally), transmitted to the client terminal 14 to confirm receipt of the electronic document 17 by the server 21.

In an alternate non-limiting embodiment, the complete electronic document 17 could be sent to the printer server. If the complete electronic document 17 is transmitted, the electronic document 17 is received by the printer server's message handler, which, if required, decodes the electronic document 17 and sends the graphic image file 17a to it's local printer.

The resulting hardcopy document 25 is inserted into an envelope to form a letter which is then submitted into the postal network 26 for distribution to the recipient's address, and thus the recipient 12, via the postal network 26. The formation of the letter could be an automated process performed at the mail distribution centre.

In a further possible embodiment, server-side software resident on the server 21 reads the recipient's address and generates a suitable barcode or DPID, or uses a barcode or DPID generated at the client terminal 14, so as to add the barcode or DPID to the hardcopy document 25 or the envelope for faster, cheaper or more efficient delivery via the postal network 26.

In a further example, the splitting of mail merges into individual letters is provided. A mail merge is a set of similar documents generated on a computer and intended for multiple recipients. It is normally sent to a printer as a single document print job and the user then is required to manually sort the printed hardcopy pages for each recipient. Therefore, if the mail merge is a two-page document to one hundred recipients, it is sent to the printer as a single two hundred page document. The system can use special codes at the end and/or beginning of a mail merge template to establish the start and the end of each individual document and can therefore break-up a two hundred page single document into the one hundred separate two-page documents. This therefore allows the system to automatically process the documents on the server without human intervention. If this was not the case, it would be required to manually process/sort the documents before posting, or the first recipient would receive all the merged documents in the post. This allows the mail merge to be performed on the client terminal 14 rather than the server 21. This same principle applies to any job where multiple letters are sent to the printer as one job, i.e. end of month statement runs, etc. Alternatively, the entire mail merge job can be sent as a whole and the processing into separate documents is carried out by software on the server.

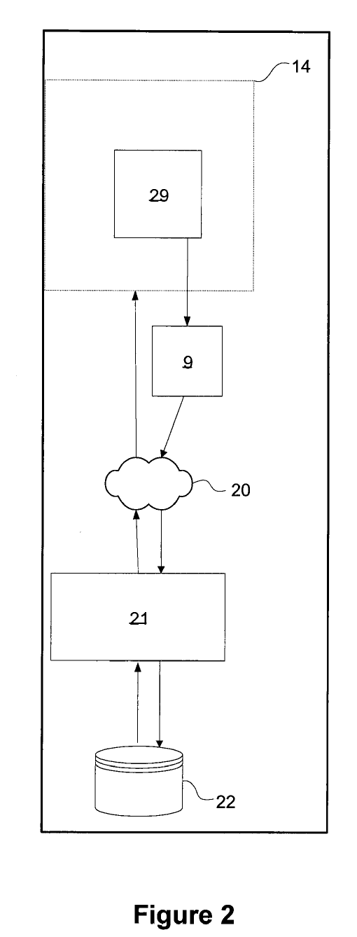

Referring to FIG. 2, the sender 11 can use a document manager 29 on the client terminal 14 to view a summary of all electronic documents sent and their status. The document manager 29 can also be used to preview any electronic documents or graphic image files sent to the server 21. The document manager 29 transmits a query 9 to the server 21 via computer network 20. This results in a query of the database 22 for the most recent status, for example a status could relate to an electronic document or graphic image file being queued, sent, received, printed, posted, failed, etc. Also preferably, there is provided a local client-side database or file record which is regularly updated whenever the database 22 is queried.

In another embodiment, access to the status of delivery of documents can be provided by allowing a sender 11 to log into the server 21 via a web browser and query the status of electronic or hardcopy documents by using the unique identification number and an account number and password.

In a further alternative embodiment, a mail distribution centre, for example a local post office, prints the graphic image file 17a. This ensures that the first time the hardcopy document 25 enters the postal network the hardcopy document 25 is free from dangerous biological or chemical agents, or other hazardous material. This procedure also ensures that the hardcopy document 25 is “least cost” routed by electronic means to a physical printing point closest or close to the recipient's address, and not the sender. That is, physical transportation costs associated with hardcopy documents are reduced.

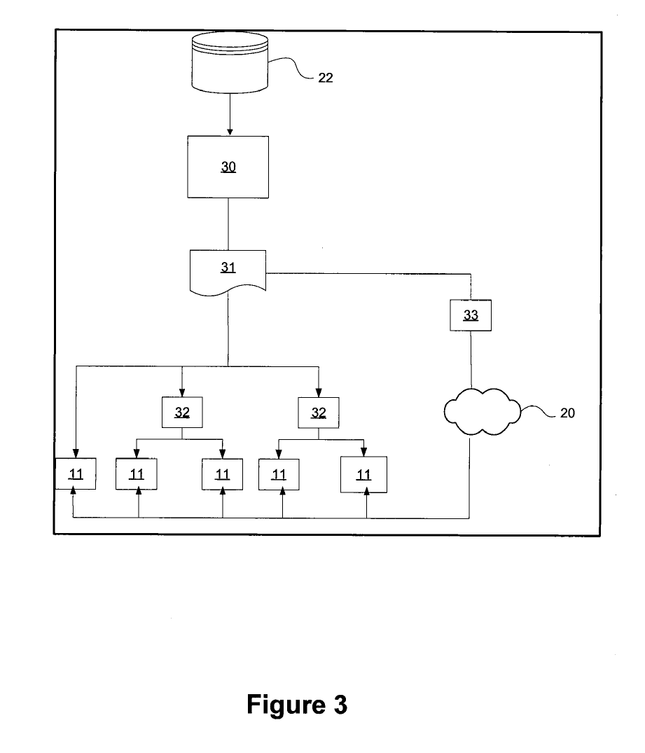

According to a further aspect of a non-limiting embodiment, and referring to FIG. 3, a billing system 30 is shown that can periodically, for example monthly, retrieve information from the database 22 to produce an invoice 31 of charges accrued for each sender 11, or for any intermediate resellers 32 offering the system or method. The billing system 30 can also produce a periodic, for example daily, journal 33 of transactions for each sender 11. If requested, the journal 33 may be transmitted to each sender 11 via the computer network 20. This allows an intermediary payment structure to be set-up for allocating commission payments to various parties.

### Virtual Letterhead

According to a further aspect, there is provided a “virtual letterhead”. In one form, users may elect to print one or more letters in a single print stream using image capture tool 15, for example which can be provided as a selectable specific printer. In this form, content that needs to be repeated for each letter (e.g. logo, return address, contact information, disclaimers, etc.) must be included in the original print steam. This makes the original print stream larger than necessary thereby causing processing delays (e.g. the letters take longer to print and to analyse). In some cases, users may have existing application documents 13 that were designed to be printed on a page of paper provided with a pre-printed letterhead. It may not be cost effective for these users to change the legacy applications that generate such letters.

In an enhanced form, users are able to print a letterhead or the like using image capture tool 15, for example a printer driver, and save the letterhead as a “virtual letterhead”. Users would then be able to select one or more virtual letterheads to be used with one or more letters. Furthermore, a user's letterhead might be split up into composite parts, for example one set for the headers and another for the footers. The virtual letterhead, or composite parts thereof, could be applied to letters using the following rules:

1. If the letterhead consists of a single page, then the letterhead would be printed on the first page of each letter.

2. If the letterhead consists of n pages (where n is greater than 1), then the first n-1 pages of the letterhead would be printed on the first n-1 pages of each letter. The last page of the letterhead could then be printed on all of the remaining pages of each letter.

With respect to printing a page of the letterhead on a page of the letter, the letterhead would preferably be rendered first and then the corresponding page of the letter (to simulate the process of printing the letter to traditional letterhead).

A virtual letterhead would be associated with a specific document ID (unique GUID). If the document ID is not recognised on server 21, the letter could be printed on plain paper. For large customers, server 21 could be set-up to divert letters that included a specific document ID to be printed on an actual hardcopy letterhead (quicker and less costly). In the alternative, printer(s)/printer server(s) 24 could be pre-loaded with the softcopy virtual letterhead and server 21 and/or printer(s)/printer server(s) 24 could substitute specific document ID's with the appropriate printer commands to render the softcopy virtual letterhead, for example using PPML. Alternatively, the softcopy virtual letterhead could be passed to the printer(s)/printer server(s) 24 at the same time as the actual print stream.

In a particular method embodiment for printing a hardcopy document with a letterhead, the method includes, at the server, receiving the electronic document from the terminal. The electronic document includes at least the graphic image file and the document ID, the document ID being associated with a particular letterhead and the graphic image file having been obtained from an application document. A document ID may be unique to each unique instance of a letterhead, but a document ID can be reused when a letterhead is required again. The graphic image file is transmitted to the printer server to be printed with the letterhead as the hardcopy document by the printer, the letterhead having been obtained or retrieved using the document ID.

The letterhead can be obtained or retrieved in a variety of ways, for example the letterhead can be obtained from the database and transmitted to the printer server with the graphic image file. Alternatively, the letterhead can be obtained from the database and transmitted to the printer server separately to the graphic image file. Also alternatively, the letterhead can be obtained from a memory associated with the printer or the printer server, e.g. a local or internal hard disk or solid state memory.

A user is preferably provided with a selectable option at the terminal so as to be able to select one of a plurality of letterheads for printing, which produces the document ID. For example, the user could select a specific letterhead prior to printing or have previously selected a default letterhead. In another form, the letterhead can include composite parts. A user can be provided with a further option at the terminal to simply select all of a letterhead, or only part or parts of the letterhead, e.g. only a logo or a header section, for printing.

In a particular example, the instruction file may contain the document ID. The instruction file may also still contain the unique identification number or any other required or useful information. In one possible form, the document ID (GUID) could be the same as the unique identification number, although this is not essential and may not be preferable.

### Silent Send

According to a still further aspect, there is provided a “silent send” mode. In one form, users print one or more letters in a single print stream to the image capture tool 15, for example a printer driver. Users may preview their letters, select attachments and/or virtual letterhead, and then submit their letters. However, in this form, there is no provision of any function for attachments, virtual letterhead, physical inserts, envelope stock, etc., to be automatically used with submitted letters.

In an enhanced form with “silent send” mode, letters are automatically submitted for production with no further user intervention. A user selectable option can be provided to enable the user to simply and readily select a resource for a printing job. For example, the user selectable option may be a wildcard string. Lists of wildcard strings can be associated with an attachment, physical insert, virtual letterhead, a type of physical paper (e.g. with a hardcopy letterhead already present or a size of paper), a type of envelope, etc., (herein referred to as “resources”). When a new set of letters is printed to image capture tool 15, for example a printer driver, the name (or other identifier) for the new print stream can be compared with the wildcard strings associated with each available resource. For every match found, the corresponding resource would be added to the original letters. In a standard mode, this would save the user several steps as the letters would automatically include required resources. This would also allow for features such as attachments and virtual letterhead to be used for letters printed using the “silent send” mode.

The document ID and/or the wildcard string can be utilised to cause the graphic image file, when printed, to be selectively associated with the resource, which may have been preprinted. That is, the user can select a virtual resource, such as an attachment or physical insert, which is then physically used with a printed graphic image file. For example, the resource could be a preprinted attachment or physical insert which is associated with the printed graphic image file by both the printed graphic image file and the attachment or physical insert being inserted in an envelope together for mailing.

Additionally, the following example characteristics/features could also be controlled by using wildcards:

1. Colourmode (colour or monochrome);

2. Simplex/duplex;

3. Ignore first page;

4. Department (billing codes);

5. Email Address (contact information); and/or

6. Return address

7. Job settings

8. Product settings.

### Ignore Page

According to a still further aspect, there is provided an “ignore page” command or function. In one form, users print one or more letters in a single print stream to the image capture tool 15, for example a printer driver. The first page of each letter should include a delivery address. The delivery address is then extracted from each letter. If a user wishes to send a standard (not personalised) brochure or document to a distribution list, the user must add the delivery addresses to the brochure (which may be white on white, that is not visible to the recipient). This process requires that the user modifies their standard brochure and print a large print stream (since the entire brochure must be printed for each recipient).

Another problem with this form is that it is difficult or problematic to use with many document imaging systems. Many document imaging systems store documents as images (e.g. TIFF). Although such documents may be printed to the image capture tool 15, for example a printer driver, software resident on server 21 may not be able to extract the delivery addresses because they are not included in the print stream as text. Although the delivery address is known by the document imaging system, there is no way to pass this information to server 21.

In an enhanced form, the user is able to specify that a page of each letter is to be ignored, preferably, for example, the first page of each letter is to be ignored (not printed) except for address extraction. Using this enhancement, users could print a standard brochure or other document as an attachment (only printed once) and then create a simple mail-merge from their distribution list. Such a mail-merge could include nothing but the delivery addresses. This would greatly simplify (and reduce resources required including disk storage and network bandwidth) the process of mailing of standard brochures or other documents. The recipient's address may be extracted from the graphic image file at the server or at the printer server.

This enhanced form would also facilitate the use of system 10 with document imaging systems. The document imaging systems could be modified to print a trivial cover page with a delivery address for each letter. These trivial cover pages would be used to extract the delivery address but otherwise be ignored.

### Consolidation of Application Documents

In the system disclosed in Australian Patent No. 2003254402, filed on 28 Aug. 2003 by the Applicant, a software application prints one or more letters in a single print job. A user is then able to parse the print stream to determine where the letters start and end. After the user has reviewed the letters, they may be submitted together to a server. In some situations, software applications (for example MYOB, FASTRACK, etc.) have been designed to print letters individually. Although such letters can be submitted for processing, the additional time and actions required to open, review and submit each letter individually makes the use of the system uneconomical. Attempts to merge the letters before submission to the server have proved ineffective because the separate letters can often use different embedded fonts and other elements. These differences make it very difficult to separate the letters in such a merged print stream.

According to a particular aspect, there is provided a means for “consolidation of application documents”. An arbitrary number of print streams may be consolidated into a single job as a virtual print stream for submission to the server. This can dramatically reduce the time it takes for some users to submit mail. In one form, the steps are as follows:

1. The print driver is set to print the application documents without initiating submission to the server;

2. The user “prints” a series of application documents (as would normally be done to a local printer);

3. The user opens an application, for example a “Mailroom” application, and/or navigates to a specific folder or virtual folder being a collection of objects in different locations, for example called a “New” folder or virtual folder;

4. The “New” folder or virtual folder contains all of the graphic image files (e.g. letters in WYSIWYG form as previously described) obtained from the application documents to be printed by a remote printer;

5. The user selects all (or a subset) of the graphic image files in the “New” folder or virtual folder;

6. The selected graphic image files can then be consolidated into one virtual print stream;

7. The user can then review and submit the selected graphic image files to the server for subsequent printing using the same tools that would have been used had each application document been printed separately as single print streams.

In another form, a user is not required to review/open the “Mailroom” application or the “New” folder or virtual folder. By associating a timer with the “New” folder or virtual folder all graphic image files (or the application documents from which they are derived) that match a certain description or condition can be automatically or semi-automatically uploaded/submitted periodically, for example by setting a timing parameter to upload the files every x minutes/hours. As a specific illustrative example, all graphic image files starting with “Invoice*.*” could be aggregated and uploaded every 30 minutes, but graphic image files starting with “Statement*.*” could be uploaded every 240 minutes.

Internally, the application documents are kept separate so that different fonts and other elements within the application documents do not cause parsing errors. In fact, application documents with completely different structures and formats could be consolidated in this manner. Preferably, a pre-requisite for such consolidation is that the address for all the application documents is in roughly the same location (e.g. a user should be able to draw a rectangle that could contain the addresses for all the application documents but no other blocks of text that could be mistaken as part of an address).

### Non-Printable Regular Expressions

As discussed hereinbefore, in the system disclosed in Australian Patent No. 2003254402, addresses can be extracted and printed on cover sheets that are visible through an address window of a windowed envelope. In this prior system it can be beneficial for a user to include a reference, for example alpha-numeric characters, on the first line of an address for document identification purposes. These forms of references, allow the user to identify letters/documents. Such a reference can be included in an address as non-printable or non-visible text, for example as white text on a white background. The server software can then suppress them from cover sheets and returned mail reports.

In various legacy systems/software, for example used to produce an application document, it may be impractical to colour a reference in a particular colour, for example as white text or as the same colour as a particular background, to blend into the background and not be visible. In this situation, the prior system/software can delete the reference from the files after processing but prior to printing. This allows legacy systems to print the reference in black in the print stream, but for the reference not to been seen on the final printed document/letter.

To at least partially address these issues, and according to a particular embodiment, there is provided a means to provide and handle regular expressions, preferably non-printable regular expressions. The client software is adapted to be able to recognize and parse such regular expressions. The regular expressions can include, for example, alpha-numeric references, processing options and delivery options. The client software can suppress the regular expressions from the address extraction procedure so that the added text, i.e. the regular expression, does not take up one or more lines of the address and so that the user can preview the results. The user is then able to determine the format for the regular expression such that one or more of the following sending options, provided by way of example, may be extracted:

1. Reference characters/number—used for letter tracking;

2. Processing options—to control processing options such as the suppression of first page printing (e.g. the first page of a letter is used for address extraction only);

3. Attachment options—to control which attachments are included with a letter (e.g. arbitrarily, REF=12345 has a rule that attaches attachments 1, 3 and 5);

4. Letterhead options—to control which letterhead is under-laid on a letter (e.g. arbitrarily, REF=12345 has a rule that attaches letterhead “My Letterhead 1);

5. Account options—to control which account a letter is charged to. A particular company may have numerous accounts (e.g. arbitrarily, REF=12345 charges a letter to account ADR12345);

6. Logo on envelope option—to control which logo shows on an envelope. A company may want to use different logo's on their envelopes for different documents (e.g. arbitrarily, REF=12345 uses logo1);

7. Insert options—to control which inserts are included with a letter (e.g. arbitrarily, REF=12345 includes a reply raid envelope with stock code RPE12349);

8. Delivery Time options—to control when a letter is printed (e.g. arbitrarily, REF=12345 DATE=120606 can print a letter on the 12th day of Jun. 2006);

9. Archive options—to control whether the item is archived locally or if a rendered copy (e.g. a PDF copy) is sent back from the processing centre to the company/user along with relevant details (e.g. a XML file) so that the copy can be ingested into an archiving system;

10. Stock options—to control the stock on which a letter is printed (e.g. arbitrarily, REF=12345 STOCK=GFDR3); and/or,

11. Delivery options—to determine how the letter/document should be delivered to the end user (e.g. via post, email or FAX). The delivery option may be preset to a default delivery option, for example via post as hereinbefore described.

The regular expression may include a unique identifier such as a Globally Unique Identifier (GUID) to ensure a line of the address is not mistakenly parsed as part of such a regular expression.

For example, the following regular expression could be used to send a letter by FAX: <KMT2VCH976GQM32C2RJF84GJ9KFD REF=D123456 FAX=0730100567>; or the following regular expression could be used to send a letter by email: <KMT2VCH976GQM32C2RJF84GJ9KFD REF=D123456 EMAIL=solutions@easymail.com>; or the following regular expression could be used to send a letter through the post with suppression of first page printing: <KMT2VCH976GQM32C2RJF84GJ9KFD REF=D123456 NOFIRSTPAGE>.

Additionally or alternatively, the regular expression may be located or positioned in another area of the document, that is besides the address location. If the user selects this other area, the document can be processed using the same rules, that is the regular expression does not have to be located in or as part of the address.

Furthermore, the user could use a regular expression as part of the actual name of the document, e.g. Word Invoice 12345 REF=D123456 FAX=0730100567, or Word invoice FAX=0730100567.

It is also possible that certain elements are treated as regular expressions and certain elements are triggered to look up a rule. For example, if REF=12345 and a user wanted the document to be associated with account ADR12349 and also include Attachment1, options include either:

using regular expression—REF=12345 ACCOUNT=ADR12349 ATTACHMENT=Attachment1; or

using regular expression—REF=12345, and using a rule in a rules engine that automatically knows to associate with account ADR12349 and include Attachment1.

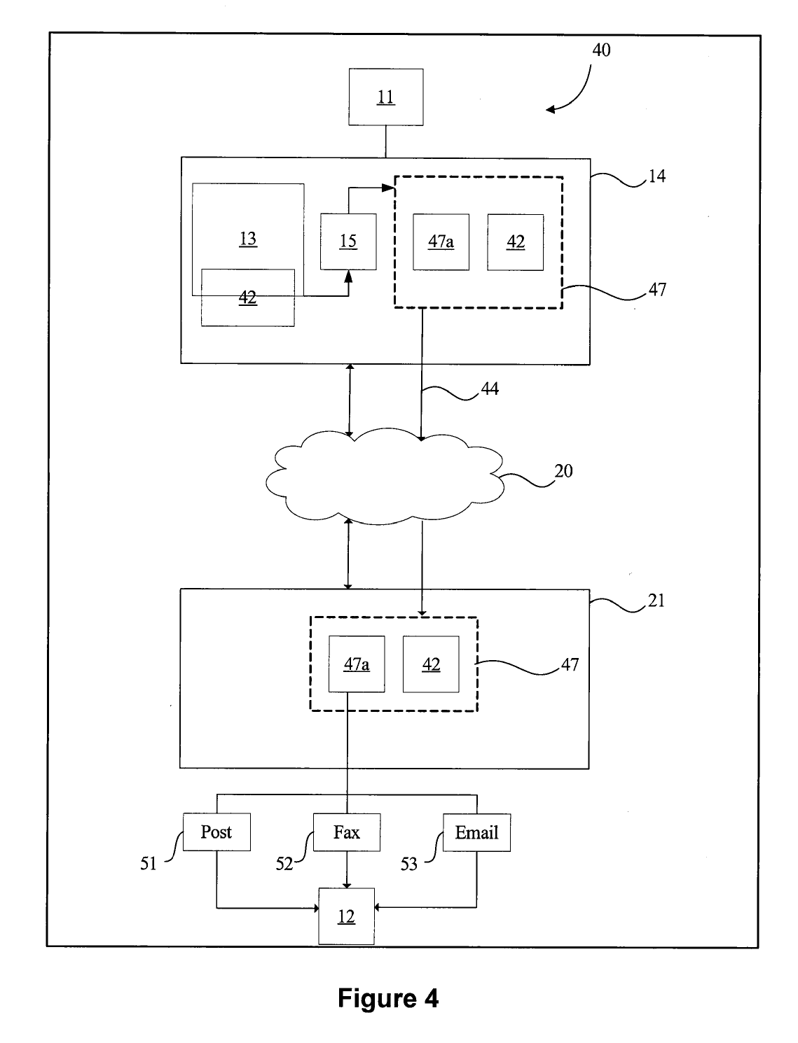

Referring to FIG. 4, there is illustrated an example system 40 and associated method for using regular expressions. Application document 13 is intended to be delivered by sender 11 to recipient 12. Application document 13 is created on or received by sender/client terminal 14. Application document 13 includes regular expression 42. For example, regular expression 42 may be included in an address box or a location near the address box, or in any other part of application document 13. Additionally or alternatively, regular expression 42 may be part of or associated with the name of application document 13.

Image processing tool 15, or equivalently printer driver 15, is resident on terminal 14 and operates on the application document 13 to generate graphic image file 47a and to extract or parse regular expression 42. Graphic image file 47a and regular expression 42 can be associated or collated with, in or as part of electronic document 47, or equivalently electronic file 47. Thus, electronic document/file 47 includes at least graphic image file 47a and one or more regular expressions 42, with graphic image file 47a obtained from application document 13 and one or more regular expressions 42 extracted or parsed from application document 13.

Graphic image file 47a is transmitted 44 to one or more servers 21 via network 20 together with one or more regular expressions 42 as part of electronic document/file 47. Electronic document/file 47 is received at one or more servers 21. Processing software resident on one or more servers 21 processes the one or more regular expressions 42 to obtain, for example, delivery options concerning how graphic image file 47a should be delivered to recipient 12. As non-limiting examples, delivery options may include via post 51, facsimile 52 and/or e-mail 53. One or more servers 21 can act on one or more regular expressions 42 to effect delivery of graphic image file 47a via the delivery mode indicated in one or more regular expressions 42. Alternatively, a delivery option may not be specified in one or more regular expressions 42 and a default delivery option may be used, for example which may be known as a preference for recipient 12 and such information can be retrieved by one or more servers 21 from a database.

This allows a wide variety of instructions to be sent as one or more regular expressions 42 by incorporating such one or more regular expressions 42 in or with an application document 13. The one or more regular expressions 42 are extracted or parsed and thus not printed as part of graphic image file 47a.

By default, image processing tool 15 may look in an address area or other location in application document 13 for regular expression 42. However, such a default is not essential and it may be provided that a user can specify another part or location of application document 13 where one or more regular expressions 42 are located.

A regular expression can include an option parameter when appropriate, for example, an option parameter for delivery options may be “post”, “fax” or “e-mail”. Alternatively, a regular expression may trigger a rule from a rules database that automatically includes or associates a specific option parameter with the regular expression. For example, a specific regular expression for a particular recipient/client may always have a default delivery option, account number, attachment, etc.

Image processing tool 15, i.e. printer driver 15, provided on terminal 14 thus provides a computer program product for delivering a document to a recipient 12. Software resident on one or more servers 21 for processing electronic document/file 47 and forwarding graphic image file 47a provides another form of computer program product for delivering a document to recipient 12.

### Matching Physical Media

According to another aspect, there is provided a means for verifying the correct matching of physical media (i.e. stock, paper with letterhead or other indicia, letters, envelopes, inserts, stationery, etc.) to graphic image files. For example, to match a particular physical medium (e.g. a hardcopy piece of paper with a pre-printed letterhead) to a particular graphic image file that is to be printed on the particular physical medium.

As discussed previously, especially, but not necessarily, for large customers, server 21 could be set-up to divert letters that included a specific document ID to be printed on an actual hardcopy letterhead as this process is quicker and less costly than also printing a letterhead on blank paper.

This can give rise to a problem in ensuring that correct virtual print streams, i.e. graphic image files, are printed on or associated with the correct physical media. Physical media may include particular stock (e.g. a company's paper letter stock), paper with a letterhead (e.g. pre-printed logo and/or contact information), paper with pre-printed indicia (e.g. images, watercolours, text, etc.), a type of paper (e.g. coloured paper or paper of a particular quality), an envelope (e.g. with a company's branding and/or return address), an insert (e.g. return prepaid envelope, additional envelope content, etc.) and/or particular stationery, etc. For example, if a user or client wants to outsource the printing of mail to an external party, but have letters printed on one or more particular letterheads, complications can occur in ensuring that the correct virtual print streams are printed on or associated with the correct media. As a specific example, the print stream for customer A needs to print on Customer A's stock (i.e. paper with Customer A's letterhead).

In prior art systems this matching process is managed by having manual systems and manual visual checks to ensure documents are printed on or associated with (e.g. if using an insert in an envelope) the correct media. However, manual systems and manual visual checks are prone to error. For example, mismatching can occur if: an operator does not perform a visual check; an operator performs a visual check but does not notice a document is being printed on the incorrect media; or an operator performs a visual check and verifies that present matching is correct, but later documents can be printed on incorrect media (e.g. some of the correct media was loaded on top of incorrect media in a printer tray).

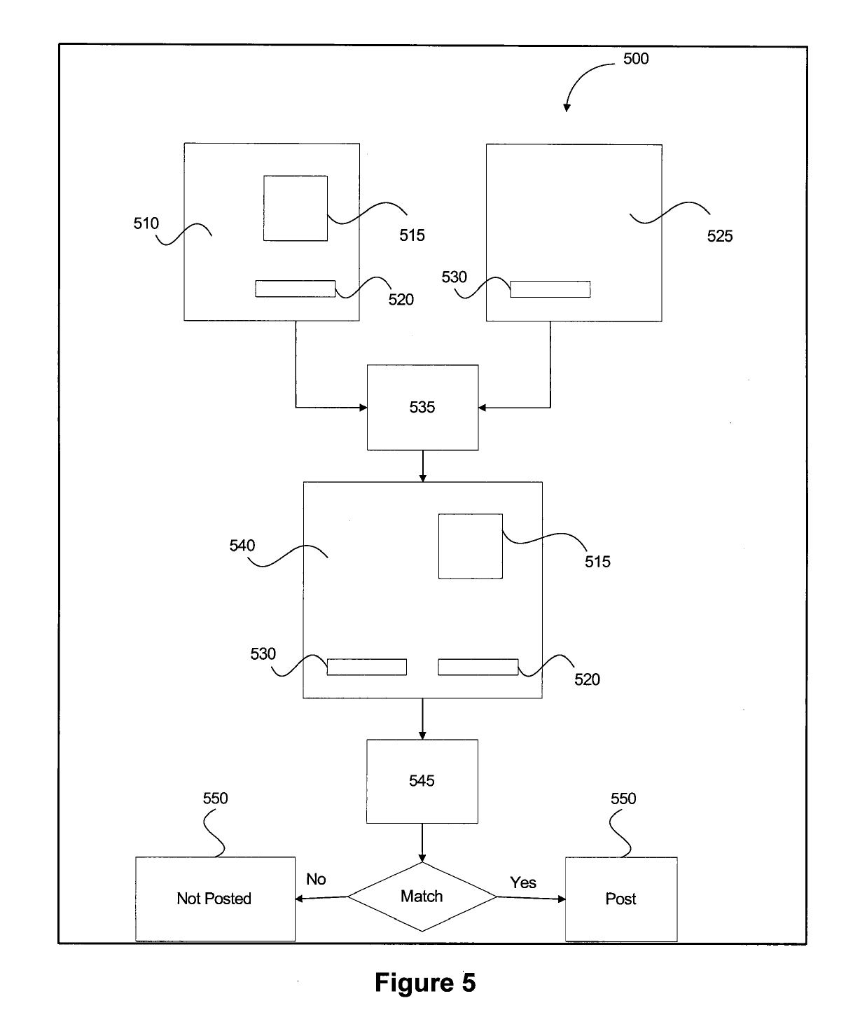

Referring to FIG. 5, there is illustrated an example method for providing a high integrity system to ensure or verify that graphic image files associated with a particular entity, e.g. company A, are printed on particular physical media, e.g. company A's letterhead. The method 500 includes:

1. A physical medium 510 (e.g. paper) is pre-printed with a letterhead 515 and a medium identifier 520 (e.g. a barcode) identifying the particular physical medium with letterhead.

2. The graphic image file 525 (sent as a virtual print stream to printer 535) is annotated to include a document ID 530 (e.g. a barcode) for each graphic image file (or possibly for each page of a letter represented by graphic image file 525). If graphic image file 525 is required to be printed on a particular physical medium identified as “AB123”, then an identifier for “AB123”, a check digit or some other mapping of the identifier is encoded as, or into a part of, the document ID for each graphic image file 525, or each page within graphic image file 525.

3. Graphic image file 525 is routed to printer 535 with physical medium corresponding to “AB123” loaded for printing, and a hardcopy document is generated by printing graphic image file 525, including document ID 530, on physical medium 510 which includes medium identifier 520. Thus, there are now at least two identifiers (e.g. barcodes), one from the pre-printed media, and one from graphic image file 525 sent to printer 535 as a virtual print stream. The two identifiers can, but need not be, represented in the same format.

4. The printed hardcopy document 540 is then scanned by scanner 545, for example hardcopy document 540 can be passed through a high speed barcode reader that may or may not be linked to a letter folding and inserting machine. Scanner 545 reads pre-printed medium identifier 520 and document ID 530 to determine if there is a match between medium identifier 520 and document ID 530. The determination can occur at scanner 545 or an associated terminal.

5. If there is a correct match then hardcopy document 540 is passed to a folding and inserting process (or some other mailing process) to be posted at step 550. If there is not a correct match (i.e. graphic image file 525 has been printed on the incorrect stock 510) then hardcopy document 540 is rejected and is not posted at step 555, and can be passed to a recovery process to effect printing of graphic image file 525 on the correct stock.

If a pre-printed insert needs to be included with a letter prior to posting (e.g. a brochure or reply paid envelope), then the folding and inserting machine can use a medium identifier reader (e.g. a barcode reader) on the insert hopper. When the machine pulls the insert, a similar matching process between a medium identifier for the insert and a document ID ensures that the insert pulled is the correct insert that should be associated with a particular graphic image file. The medium identifier read from the insert may be matched against a file or data sent to the inserting machine, for example from scanner 545, against an external database, and/or against the document ID which might be read again at some point in the inserting process.

A representation of medium identifier 520 and/or document ID 530 (which may be the same barcode) may also be utilized on the outer envelope of a letter and used to match the envelope (which may be branded or have a particular return address) to the hardcopy document, insert or other content of the letter. Also, a representation of medium identifier 520 and/or document ID 530 on the outer envelope can be readily used to determine the content of the envelope by scanning the envelope and retrieving information from a database.

In various forms, medium identifier 520 and/or document ID 530 may be represented as a barcode, alphanumeric code for Optical Character Recognition (OCR), or indicia or mark for Optical Mark Recognition (OMR) or Intelligent Character Recognition (ICR). Any suitable identifier may be used and could be printed in ink that is visible or substantially invisible to the human eye, for example inks that can be read using infrared light.

Furthermore, medium identifier 520 could be scanned before physical medium 510 is loaded into printer 535 to inform a print controller about what medium 510 is in printer 535. The print controller may optionally not print the graphic image file 525 if the scanned medium identifier 520 is not matched or determined as correct. For example, the print controller could be informed of the document ID by data retrieval from a database or by software emulated scanning of the received graphic image file prior to printing. Still furthermore, if the scanned document ID does not match the scanned medium identifier then further printing on the same type of physical medium can be stopped to ensure any further mismatched paper is not wasted.

According to another aspect, the client side software can be provided with the ability to map the virtual print stream to physical media, e.g. stock, by using a virtual letterhead, as hereinbefore discussed, as the mapping means.

For example, a user may effect printing of a virtual print stream and add or select a virtual letterhead. The user can preview a graphic image file with a selected (or default) virtual letterhead prior to the electronic document, including the graphic image file, being transmitted to a server. After receipt of the electronic document, the server can remove the virtual letterhead from the print stream and cause or mark the print job to print on a specific physical medium, e.g. stock, corresponding to the virtual letterhead that was selected by the user.

### Mixed Colour Printing

According to another aspect, there is provided mixed colour printing. End users are able to electronically submit a letter, a batch of letters, an attachment, a set of attachments, or other types of page or pages. The collection of pages is herein referred to as a ‘pack’ and a user is able to submit a pack to a server for processing. After processing, one or more recipient documents obtained from the submitted pack can be, if required, printed, folded, and/or inserted into envelopes and posted.

A pack is an ordered collection of one or more sections. Each section is an ordered collection of one or more pages. A section can be or can include one or more ‘attachments’, which is comprised of one or more pages. At least one section also preferably includes one or more letters, a letter being a general reference to one or more pages which include a recipient's address, i.e. an addressed letter.

Packs, containing sections, that in turn contain letters or attachments, are used to generate or produce recipient documents. A recipient document is an ordered document that is to be printed and ultimately delivered to a recipient. Thus a recipient document may typically include one or more letters and one or more attachments. Packs, sections or individual pages can be assigned one of three colour modes: ‘monochrome’, ‘colour’ or ‘pattern’, selectively by a user or by default.

If a pack is marked as ‘monochrome’, then all pages of the pack are printed in monochrome. If a pack is marked as ‘colour’, then all pages of the pack are printed in colour. If a pack is marked as ‘pattern’, then colour or monochrome printing for each page is determined by the colour mode selected or set for the section to which a page corresponds or belongs.

If a section is marked as ‘monochrome’, then all pages of the section are printed in monochrome. If a section is marked as ‘colour’, then all pages of the section are printed in colour. If a section is marked as ‘pattern’, then colour or monochrome printing for each page is determined by the colour mode selected or set for the page.

If a page is marked as ‘monochrome’, then the page is printed in monochrome. If a page is marked as ‘colour’, then the page is printed in colour. If a page is marked as ‘pattern’, then colour or monochrome printing for the page is determined by the colour mode selected or set for the pack, or the section if no pack colour mode is defined, to which the page corresponds or belongs.

When a new pack or section is created, the colour modes for all sections and pages is set to ‘pattern’. This means that the colours used for each page is determined by the colour mode selected for the pack or section: monochrome, colour or pattern. If a user selects the ‘pattern’ colour mode for a pack or section, then the colour scheme is governed by a pattern selected by the user. A variety of patterns can be defined and provided as user selectable patterns, for example from a drop-down menu item.

For example, if the selected pattern is ‘first page colour with monochrome attachments’, then the first page of a letter from the relevant section in a pack is printed in colour and all other pages are printed in monochrome. If the selected pattern is ‘first page colour with colour attachments’, then the first page of a letter from the relevant section in a pack is printed in colour and all other pages are also printed in colour. Thus, users in most cases are able to send mail using desired patterns by simply setting the colour mode for a pack or a section. If required, however, a user can define a colour mode for one or more individual pages.

It should be noted that it is not essential to require multiple sections in a pack. For example, a pack could be formed of a single section containing one or more letters.

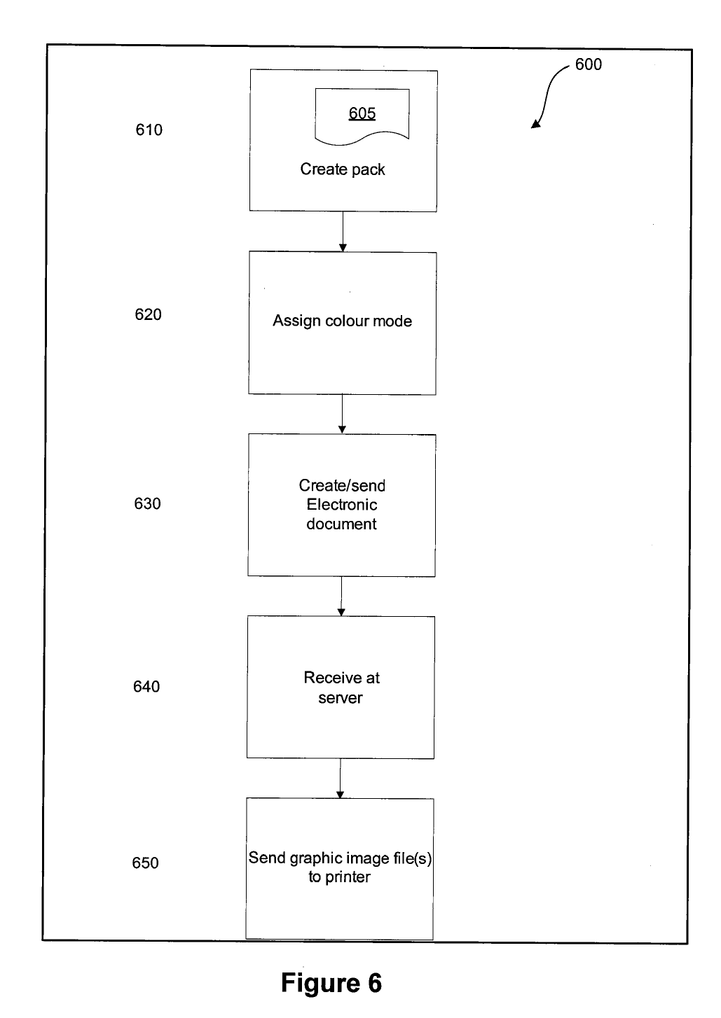

Referring to FIG. 6, there is illustrated a method 600 of mixed colour printing, where a pack includes more than one page. At step 610, a pack is created from an ordered collection of pages 605 that are created on or received at a terminal, for example by being produced from a software application. At step 620, a colour mode is assigned to the pack, one or more sections, or individual pages by a user. At step 630, an electronic document is created and sent to one or more servers, the electronic document including one or more graphic image files, being a representation of the ordered collection of pages. A graphic image file can include a single page or multiple pages. At step 640, the one or more servers receives the electronic document transmitted from the terminal. At step 650, the one or more graphic image files are sent from the one or more servers to a printer able to print the graphic image files. The ordered collection of pages 605 has thus been assigned a colour mode prior to printing, the colour mode indicative of monochrome, colour or pattern printing for each page of the ordered collection of pages 605. As discussed previously, the colour mode indicative of pattern printing results in each page printing in either monochrome or colour according to the colour mode assigned to the pack or relevant section.

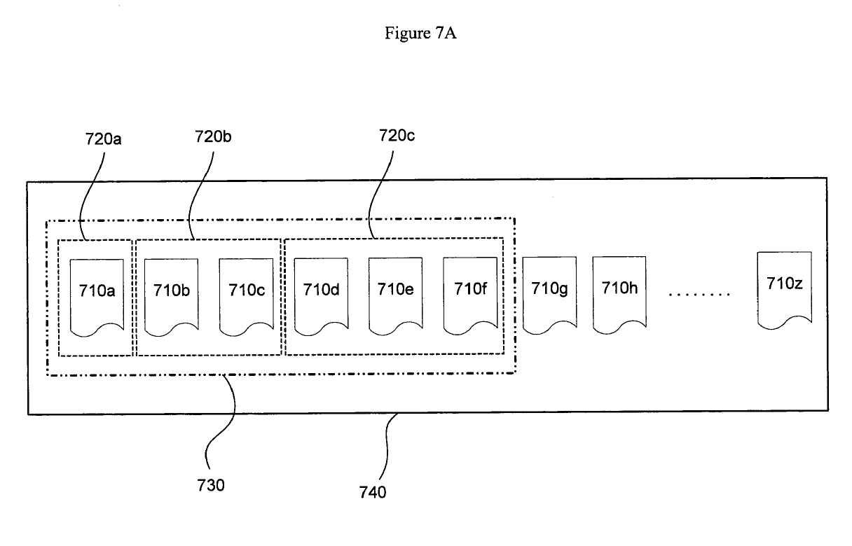

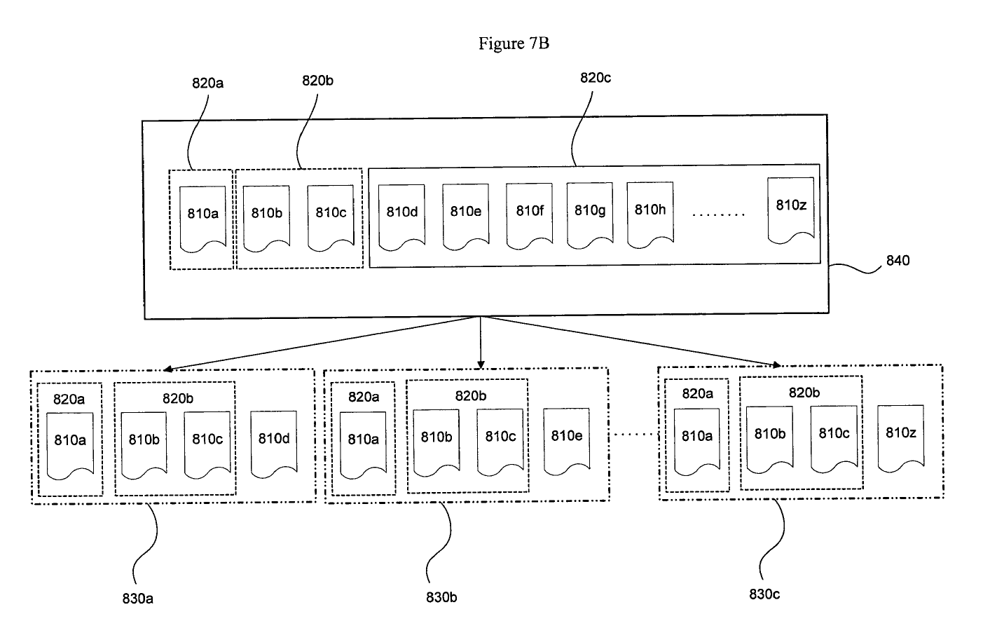

Referring to FIG. 7A, there is illustrated a pack 740. Pack 740 includes individual pages 710a, 710b, . . . 710z. The individual pages are formed into sections, for example section 720a, section 720b and section 720c. In a specific example, section 720a may be an addressed letter, section 720b may be a first attachment and 720c may be a second attachment. Hence, in this specific example, an addressed letter is provided by page 710a, the first attachment is provided by pages 710b and 710c, and the second attachment is provided by pages 710d, 7110e and 710f.

When pages and sections have been ordered or defined pack 740 is transmitted by a user to one or more servers. Pack 740 can then be processed to generate or obtain recipient document 730. Recipient document 730 is the document to be printed and delivered to the intended recipient, typically the recipient indicated in the addressed letter on page 710a. It should be noted that more than one recipient document 730 can be included in pack 740. Although pages 710g, 710h . . . 710z are shown for the purposes of illustration, pack 740 would preferably not contain pages not associated with a specific section. Pages 710g, 710h . . . 710z are illustrated to show that other recipient documents can be formed from pack 740. Addressed letters in pack 740 need not be for the same recipient.

Thus, a section is a letter or set of letters, an attachment or set of attachments, or some other type of page or set of pages. Individual letters or attachments can be comprised of one or more pages.

Referring to FIG. 7B, there is illustrated a pack 840 for application in a situation where a mail merge process is utilised. A mail merge process is utilised typically where there exists the need for one or more letters to be sent to multiple recipients with the same attachments. Pack 840 includes section 820a, section 820b and section 820c. In a specific example, section 820a includes page 810a and is a common attachment. Section 820b includes pages 810b and 810c and is a second common attachment. Section 820c includes pages 810d . . . 810z providing differently addressed letters. For example, each page 810d . . . 810z may be a letter addressed to a different recipient.

FIG. 7B illustrates how recipient document 830a, recipient document 830b and recipient document 830c can be produced or generated from pack 840. Recipient document 830a includes attachment section 820a, attachment section 820b and letter 810d addressed to a first recipient. Recipient document 830b includes attachment section 820a, attachment section 820b and letter 810e addressed to a second recipient. This process is repeated for recipient document 830c and for all differently addressed letters in section 820c of pack 840.

When an attachment is defined or included, as a section in the pack, the attachment default colour mode can be set to ‘pattern’. However, if the colour mode for the section with the attachment is over-ridden to be set as ‘monochrome’ or ‘colour’, the selected colour mode is used for the attachment when added to a pack. This allows users to over-ride the default pattern for selected attachments.

In order to select the colour mode for a pack, section or page, the user is presented with a drop down menu list containing the colour modes ‘monochrome’ and ‘colour’ together with one or more colour patterns. These colour patterns may include examples such as ‘first page colour’, ‘first page colour with colour attachments’, ‘first page colour with monochrome attachments’, ‘monochrome with full colour attachments’, or other such combinations. When the user selects a colour pattern, the colour mode for the pack is set to ‘pattern’ and the selected pattern is applied to the sections, and individual pages if required, of the pack.

While colour patterns may be defined in many different ways, one example method is to define a colour pattern as an array of values, for example alphanumerical values or signed integer values. Each value in the array could be used to determine the colour modes for one or more pages of a section or of the pack. The first value could be used to set the colour modes for the first page only. Subsequent, values could be used to set the colour modes for subsequent pages, with the last entry being used for all remaining pages if there is more than one entry in the array. If an entry is set to zero (a default value), an entire pack could be printed in monochrome. If the entry is set to minus one (−1) then the entire pack could be printed in colour. If the entry is set to a positive integer (say +x) then the first ‘x’ pages of a pack could be printed in colour.

### Detailed Specific Embodiment

The following example provides a more detailed description of one particular embodiment. This example is intended to be merely illustrative and not limiting to the scope of the present invention.

An example embodiment uses a computer program that runs on the sender's computer. The computer program consists of software written in the C programming language to run on the Microsoft Windows 32-bit operating system (WIN32) together with a custom printer driver developed using the Microsoft Windows Driver Development Kit (DDK).

After the sender has created or received an application document on their WIN32 computer terminal, the sender selects a custom printer driver which “prints” the application document by saving the application document as a series of Postscript, Portable Document Format (PDF), Printer Command Language (PCL) or Enhanced Metafile Format (EMF) files on the terminal's storage medium. The printer driver then, in turn, initiates the client-side software. The software displays the Postscript, PDF, PCL or EMF files in WYSIWYG format on the sender's (i.e. user's) computer screen with the relevant area for the correct location of the postal address highlighted. Thus the sender can tell by inspection that the recipient's address is in the correct location and can instruct the software to send an electronic document or cancel the operation. In an alternative embodiment, the software automatically examines the Postscript, PDF, PCL or EMF file for graphical text elements in the relevant area of the page and then analyses this text according to pre-programmed rules to ascertain whether the document contains a valid postal address.

The Postscript, PDF, PCL or EMF files are then digitally compressed using the ZLIB compression algorithm as specified in RFC1950 “ZLIB Compressed Data Format Specification version 3.3” (P. Deutsch and J-L Gailly, May 1996) and are then encoded using Basic Encoding Rules (BER) in accordance with ITU-T Recommendations X.690-X.691 (2002) and CCITT Recommendation X.209.

The software generates a unique identification number by using Windows internal software that creates a global unique identifier (GUID), a bit string guaranteed to be unique to a very high degree of certainty. This number is encoded in base 24 format and is used as a reference to the message in all subsequent stages, and also as key in a local database of messages maintained by the software on the sender's local terminal.

The software then generates an instruction file in Extensible Markup Language (XML) containing instructions for this particular message including the unique identification number, sender's account details, number of pages, return email address, and so forth. This XML instruction file is combined with the BER-encoded Postscript, PDF, PCL or EMF files and converted into a Secure Multipurpose Internet Mail Extensions (S/MIME) message using public key encryption in accordance with RFC2633 “S/MIME Version 3 Message Specification” (B. Ramsdell, June 1999) and RFC2630 “Cryptographic Message Syntax” (R. Housley, June 1999).

The software then opens a Transmission Control Protocol/Internet Protocol (TCP/IP) connection with the server computer over the Internet and sends the S/MIME message to the server, for example using the HyperText Transfer Protocol (HTTP) or Simple Mail Transfer Protocol (SMTP) as per RFC821. The message can also be encrypted prior to being sent using, for example, HTTP or SMTP. The message transmission is independent of any email client applications that may exist on the sender's terminal. Alternatively, the software stores the information in a queue so the message can be sent by HTTP or SMTP transmission at a later time. After transmission, the software stores the result (success or failure) in the local database.

When the sender uses a Document Manager to query the status of documents, the software looks up the local database for the identifiers of any outstanding documents. It then sends a request on these outstanding documents to the server computer using Hypertext Transfer Protocol (HTTP) commands and receives back the latest status details (received, being printed, successfully posted, rejected, not found, etc.). The software then updates the local database with this information and displays the results to the user in a Graphical User Interface (GUI).

Thus there has been provided a method, system, computer program product and/or computer readable medium of instructions for verifying the correct matching of physical media to electronic documents.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

The present invention may take the form of an entirely hardware embodiment, an entirely software embodiment, or an embodiment combining software and hardware aspects.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

1. A method of mixed colour printing of a recipient document including more than one page, the method including:
(a) receiving, at one or more servers, an electronic document transmitted from a terminal, the electronic document including a pack, the pack including one or more sections, a section including one or more pages;
(b) obtaining the recipient document from the pack; and,
(c) sending the recipient document, from the one or more servers, to a printer able to print one or more graphic image files forming the recipient document;
wherein, the one or more pages of the pack are assigned a colour mode prior to printing, the colour mode indicative of monochrome, colour or pattern printing, and whereby the colour mode indicative of pattern printing results in each page of the recipient document printing in either monochrome or colour according to the colour mode assigned to the section to which the page belongs.

2. The method as claimed in claim 1, wherein if a section is assigned the colour mode indicative of monochrome printing, then all pages of the section are printed in monochrome.

3. The method as claimed in claim 1, wherein if a section is assigned the colour mode indicative of colour printing, then all pages of the section are printed in colour.

4. The method as claimed in claim 1, wherein a section provides an attachment, and a colour mode is assigned to each page of the attachment.

5. The method as claimed in claim 1, wherein the colour mode assigned to each page is a result of a user selecting a colour pattern.

6. The method as claimed in claim 5, wherein the colour pattern is represented by an array of values.

7. The method as claimed in claim 5, wherein the colour pattern is selected from a group with elements representative of: ‘first page colour’, ‘first page colour with colour attachments’, ‘first page colour with monochrome attachments’, and ‘first page monochrome with colour attachments’.

8. The method as claimed in claim 1, wherein more than one section is included in a pack and the pack is assigned a colour mode, and wherein if the pack is assigned the pattern colour mode, then colour or monochrome printing for each page is determined by the colour mode assigned to the section to which a page belongs.

9. A system for mixed colour printing of a recipient document including more than one page, the system including:
one or more servers to receive an electronic document transmitted from a terminal, the electronic document including a pack, the pack including one or more sections, a section including one or more pages, and the one or more servers able to transmit a recipient document to a printer for printing of the recipient document;
wherein, the one or more pages of the pack are assigned a colour mode prior to printing, the colour mode indicative of monochrome, colour or pattern printing, and whereby the colour mode indicative of pattern printing results in each page of the recipient document printing in either monochrome or colour according to the colour mode assigned to the section to which the page belongs.

10. The system as claimed in claim 9, wherein a section provides an attachment, and a colour mode is assigned to each page of the attachment.

11. The system as claimed in claim 9, wherein the colour mode assigned to each page of the recipient document is a result of a user selecting a colour pattern at the terminal.

12. The system as claimed in claim 11, wherein the colour pattern is represented by an array of signed integer values.

13. The system as claimed in claim 11, wherein the colour pattern is selected by the user from a drop down menu in an application provided on the terminal.

14. A computer program product for mixed colour printing of a recipient document including more than one page, the computer program product configured to:
(a) receive, at one or more servers, an electronic document transmitted from a terminal, the electronic document including a pack, the pack including one or more sections, a section including one or more pages; and,
(b) send the recipient document, from the one or more servers, to a printer able to print the recipient document;
wherein, the one or more pages of the pack are assigned a colour mode prior to printing, the colour mode indicative of monochrome, colour or pattern printing, and whereby the colour mode indicative of pattern printing results in each page of the recipient document printing in either monochrome or colour according to the colour mode assigned to the section to which the page belongs.
